(19) United States
(12) Patent Application Publication
(10) Pub. No.: US 2015/0074578 A1
(43) Pub. Date: Mar. 12, 2015

(54) TEXT SELECT AND ENTER

(71) Applicant: Motorola Mobility LLC, Libertyville, IL (US)

(72) Inventors: Lifeng Liang, Beijing (CN); Kun Zhao, Beijing (CN)

(21) Appl. No.: 14/390,954

(22) PCT Filed: Apr. 7, 2012
(86) PCT No.: PCT/CN2012/073618

§ 371 Date: Nov. 7, 2014

(51) Int. Cl. G06F 3/0488; G06F 3/0486; G06F 3/0484

(52) U.S. Cl. CPC G06F 3/04886; G06F 3/04842; G06F 3/0486
USPC 715/770; 715/773

(57) ABSTRACT

In embodiments of text select and enter, selectable character strings (124) can be determined from text (118) that is displayed in display interfaces on a display device. A character string mapping table (122) can then be generated that identifies a selection position (126) of each selectable character string that is displayed. A selection of a selectable character string can be received, and the chosen selectable character string determined from the string mapping table based on a selection position on a touch-sensitive display component (106). The chosen selectable character string can then be duplicated as a text entry at a cursor position in a text edit field (120) responsive to the selection of the selectable character string and without additional user input.

This application is a National Stage Application under 35 U.S.C. §371 of PCT application PCT/CN2012/073618, filed Apr. 7, 2012, the entire contents of which is hereby incorporated by reference.

### BACKGROUND

Computer devices, mobile phones, entertainment devices, navigation devices, and other electronic devices are increasingly designed with an integrated touch-sensitive interface, such as a touchpad or touch-screen display, that facilitates user-selectable touch and gesture inputs. For example, a user can input and edit text for messaging, emails, and documents using touch inputs to a virtual keyboard (or on-screen keyboard) that is displayed for user interaction. Often a user has to type words or phrases that have already been entered and/or are displayed on the display screen of a device. Rather than typing or re-typing a word or a phrase, a user can copy and then paste the text in a text entry field. However, the number of steps needed to copy and paste a word may take longer than just re-typing the word. At a minimum, a user typically has to select the word (or phrase) to be copied, initiate a copy operation to copy the word, select a text insert location, and then initiate the paste operation.

### BRIEF DESCRIPTION OF THE DRAWINGS

Embodiments of text select and enter are described with reference to the following Figures. The same numbers may be used throughout to reference like features and components that are shown in the Figures:

FIG. 1 illustrates an example system in which embodiments of text select and enter can be implemented.

FIG. 2 illustrates an example of text select and enter in accordance with one or more embodiments.

FIG. 3 illustrates example method(s) of text select and enter in accordance with one or more embodiments.

FIG. 4 illustrates various components of an example electronic device that can implement embodiments of text select and enter.

### DETAILED DESCRIPTION

An electronic device, such as a computer, gaming device, remote controller, navigation device, or mobile phone, can include a touch-sensitive interface via which a user can interact with the device and input text, such as for instant messaging, emails, documents, browsers, contact lists, and other user interface text entry and edit features. In embodiments of text select and enter, selectable character strings can be determined from text that is displayed in display interfaces on a touch-sensitive display component. A selectable character string may be any one of a letter, a number, a symbol, a word, a phrase, a numeric string, an alphanumeric string, and/or any combination thereof. A character string mapping table can then be generated that identifies a position of each selectable character string that is displayed on the display component.

A user can select a selectable character string, such as a word or phrase or telephone number that is displayed in a text edit field, or in an application or display interface (e.g., an application window), and the selectable character string is then duplicated (e.g., entered) as a text entry at a cursor position in the text edit field without additional user input. For example, as a user enters text in the text edit field of a virtual keyboard, the user can save time by selecting previously typed words or phrases. The selected previously-typed text entry is duplicated at a cursor position in a text edit field responsive to the selected character string being selected and without additional user input.

While features and concepts of text select and enter can be implemented in any number of different devices, systems, and/or configurations, embodiments of text select and enter are described in the context of the following example devices, systems, and methods.

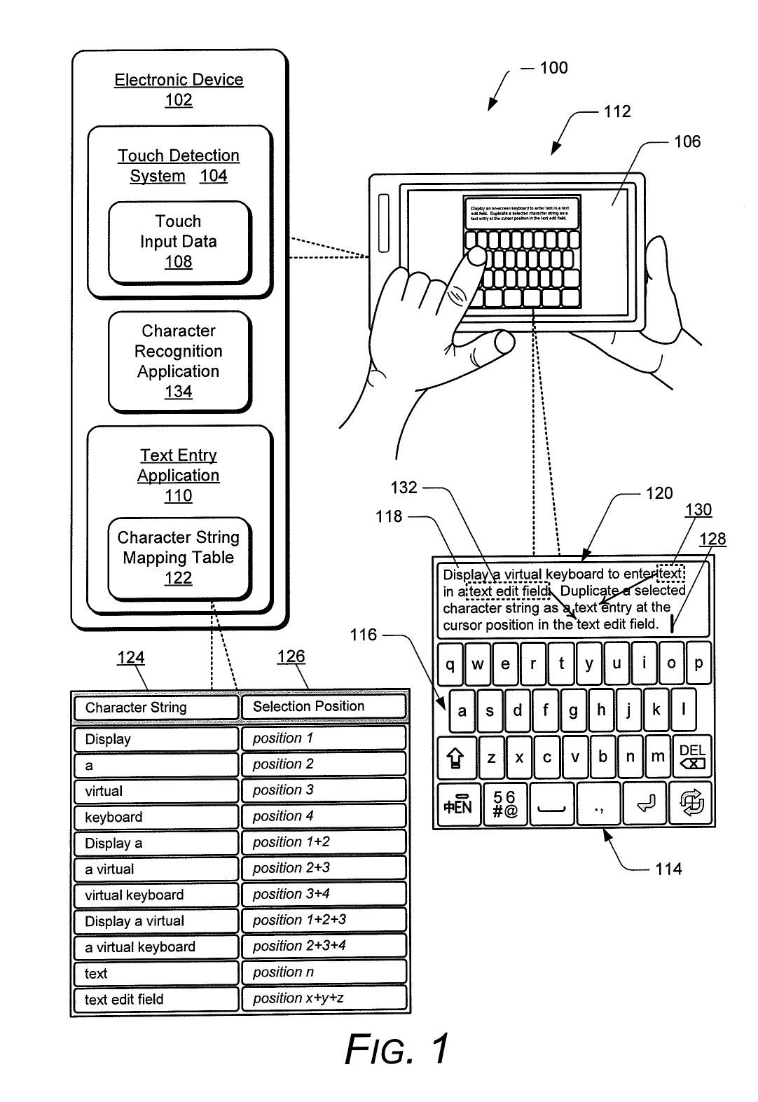

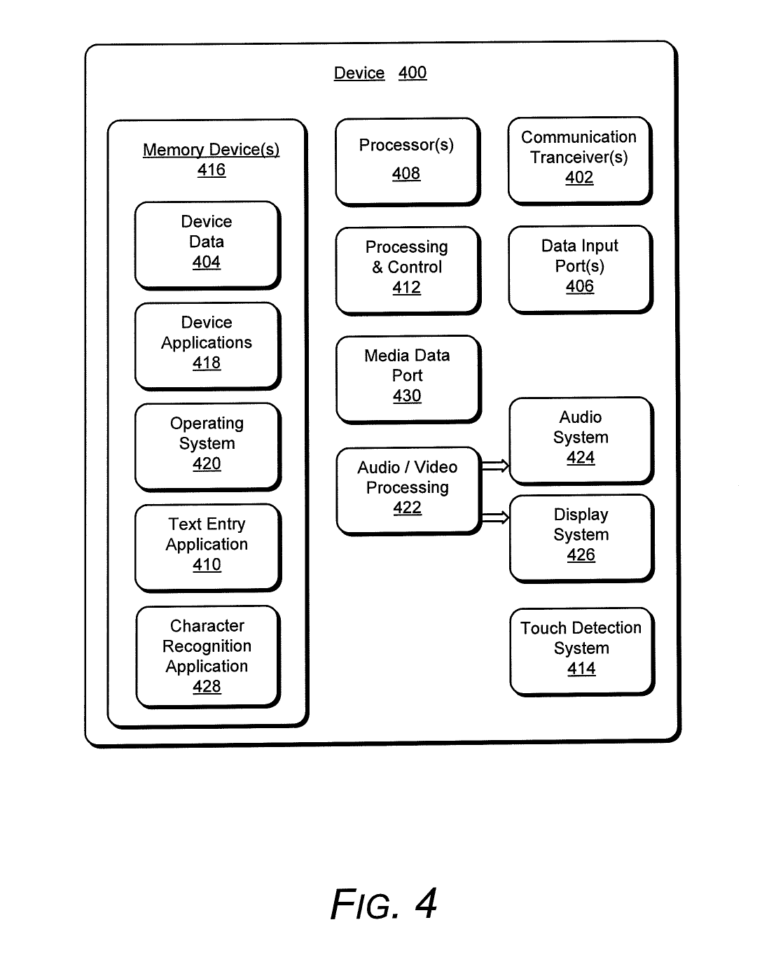

FIG. 1 illustrates an example system 100 in which embodiments of text select and enter can be implemented. The example system 100 includes an electronic device 102, which may be any one or combination of a fixed or mobile device, in any form of a desktop computer, portable computer, tablet computer, mobile phone, navigation device, gaming device, gaming controller, remote controller, pager, etc. The electronic device has a touch detection system 104 that includes a touch-sensitive display component 106, such as any type of integrated touch-screen display or interface. The touch-sensitive display component can be implemented as any type of a capacitive, resistive, or infrared interface to sense and/or detect gestures, inputs, and motions. Any of the electronic devices can be implemented with various components, such as one or more processors and memory devices, as well as any number and combination of differing components as further described with reference to the example electronic device shown in FIG. 4.

The touch detection system 104 is implemented to sense and/or detect user-initiated touch contacts and/or touch gesture inputs on the touch-sensitive display component, such as finger and/or stylus inputs. The touch detection system receives the touch contacts, touch gesture inputs, and/or a combination of inputs as touch input data 108. In the example system 100, the electronic device 102 includes a text entry application 110 that can be implemented as computer-executable instructions, such as a software application, and executed by one or more processors to implement various embodiments of text select and enter. In general, the text entry application receives the touch input data 108 from the touch detection system and implements embodiments of text select and enter.

Examples of text select and enter are shown at 112, where a user might hold the electronic device 102 with one hand, and interact with the touch-sensitive display component 106 with a finger of the other hand (or with a stylus or other input device). In this example, a keyboard interface 114 is displayed that includes a virtual keyboard 116 (e.g., displayed as an on-screen keyboard) for user-interaction to enter text 118 in a text edit field 120. In embodiments, the text edit field 120 is an example of a display interface that is displayed proximate the keyboard interface 114. As text is entered in the text edit field, the text entry application 110 is implemented to determine selectable character strings from the text that is entered and displayed in the text edit field. A selectable character string may be any one of a letter, a number, a symbol, a word, a phrase, a numeric string, an alphanumeric string, and/or any combination thereof.

The text entry application 110 is also implemented to generate a character string mapping table 122 that identifies a position of each selectable character string that is displayed in a display interface, such as in the text edit field 120. For example, the character string mapping table 122 shown in FIG. 1 includes some of the example selectable character strings 124 as determined from the text edit field 120, and a corresponding selection position 126 for each of the selectable character strings. A selection position of a selectable character string can be identified by coordinates relative to the touch-sensitive display component 106, by pixel location, digital position, grid position, and/or by any other mapping techniques that can be utilized to correlate a user selection of a selectable character string. The text entry application 110 can control the activation and deactivation of the text select and enter function as associated with the virtual keyboard 116. For example, when the keyboard interface 114 is displayed, an edit mode can be initiated to determine the selectable character strings in the display interface layout and to generate the character string mapping table.

As a user enters the text 118 in the text edit field 120, a cursor 128 may be displayed that indicates the current text entry position in the text edit field (e.g., at the end of the text as shown in this example). The cursor may also be user-selectable and can be positioned at any other position in the text edit field, such as at the beginning of the text entry, or anywhere in the displayed text. The text entry application 110 is also implemented to track and/or determine the cursor position in the text edit field 120, and can receive a position input to position the cursor in the text edit field, such as when a user selects and moves the cursor.

In embodiments of text select and enter, a user can select (e.g., choose) a selectable character string 124, such as a word or phrase that is displayed in the text edit field 120, and the selectable character string is then duplicated (e.g., entered) as a text entry at the cursor position in the text edit field without additional user input. For example, as the user enters the text in the text edit field 120 with keyboard inputs on the virtual keyboard 116, the user can save time by selecting previously typed words or phrases, such as to enter the word “text” and to enter the phrase “text edit field” as text entries. In this example, the text entry application 110 can receive a selection of a character string 124 (e.g., the word “text” at a selection position n 130, or the phrase “text edit field” at a selection position x+y+z 132) that is displayed in the text edit field 120. The selected text entry is duplicated at the cursor 128 position in the text edit field responsive to the selection of a character string and without additional user input. Note that the character string “text” is correlated with selection position n in the character string mapping table 122, and similarly, the character string “text edit field” is correlated with selection position x+y+z in the character string mapping table.

In implementations, a touch contact on the touch-sensitive display component 106 to initiate the selection of a selectable character string can be distinguished from a touch contact in the text edit field 120 to move or position the cursor 128. For example, a user can select a selectable character string for entry in the text edit field with a single-tap or single-swipe touch contact (e.g., a short duration selection or quick touch contact). Alternatively, the user can initiate moving the cursor 128 with an extended duration touch contact (e.g., a press and hold selection). In practice, a short duration is relative to an extended duration (and vice-versa), and the length of a selection for a short or extended duration can be implementation specific and/or user adjustable.

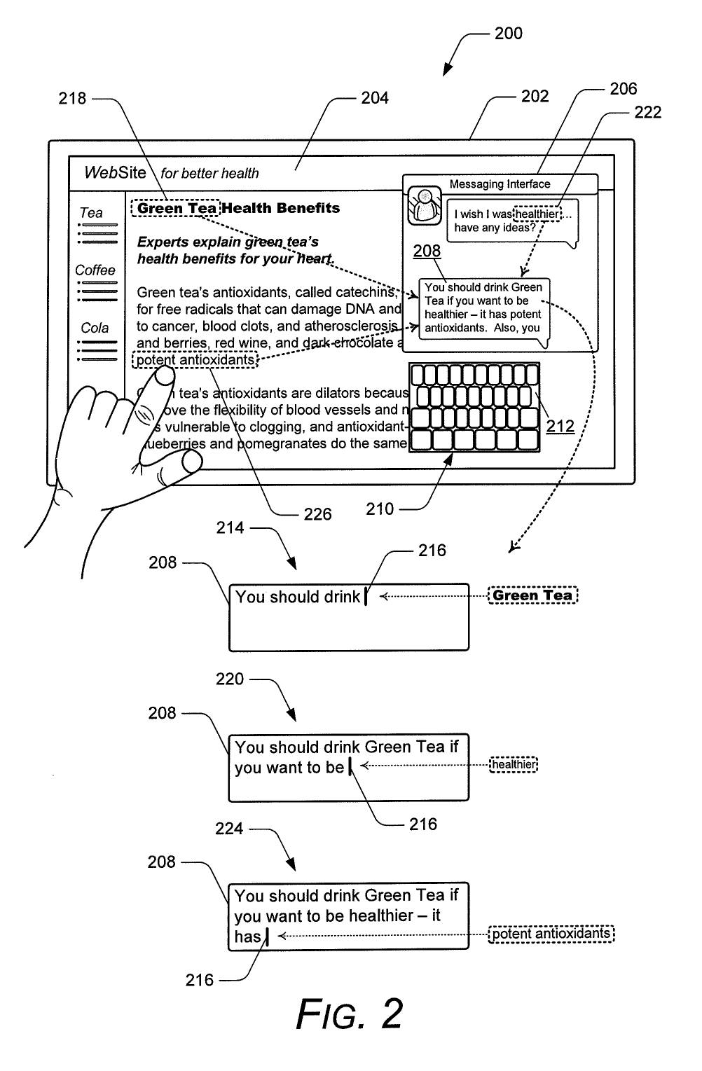

In other embodiments, a user can choose a selectable character string, such as a word or phrase, that is displayed in any display interface on the display component 106 of the electronic device 102. For example, a tablet or computer device may have several application interfaces (e.g., application windows) that are displayed side-by-side and/or overlapping, such as for word processing applications, database and spreadsheet applications, Web browser applications, file management applications, as well as for email and other messaging applications. Examples of text select and enter from multiple display interfaces is shown and described with reference to FIG. 2. Additionally, a selected character string can be entered as a text entry in any type of text edit interface, such as in the text edit field 120 with keyboard inputs (e.g., key select inputs or key swipe inputs) on the virtual keyboard 116, in a word processing, database, or spreadsheet application display interface, or in email and other messaging application interfaces, or to enter text in a Web browser application interface.

For example, a user may be reading an article on a website and want to search for further occurrences of a particular word or phrase in the article. The user can initiate a text search function on the website or Web browser interface and then touch-select the word or phrase (e.g., a character string) showing in a displayed portion of the article. The text entry application 110 receives the selection of the word or phrase that is displayed in the article on the website interface, and then enters the character string as a text entry at the cursor position in the text search field of the text search function without additional user input.

In implementations, the electronic device 102 includes a character recognition application 134 that is implemented to determine the selectable character strings by analyzing or recognizing text that is displayed in one or more display interfaces. For example, several application interfaces may be displayed side-by-side and/or overlapping. A first display interface may partially overlap a second display interface, in which case the character strings of the second display interface that are not obscured by the first display interface are determined as selectable character strings. In various implementations, any applicable optical character recognition (OCR) technique can be utilized to determine the selectable character strings from the text that is displayed in the display interfaces. For example, a scanned image (e.g., a screen shot) of the display may be analyzed using OCR to locate selectable character strings that are viewable across the entire display component of an electronic device.

FIG. 2 illustrates an example 200 of text select and enter from multiple display interfaces in accordance with the embodiments described herein. In this example, multiple display interfaces are shown displayed on a single display component 202, such as the touch-sensitive display component 106 of the electronic device 102 described with reference to FIG. 1, or on a tablet or computer device display. For example, a website interface 204, a messaging interface 206, and a text edit field 208 (e.g., also a display interface) are all displayed on the display component 202 proximate a keyboard interface 210 that includes a virtual keyboard 212. The text entry application 110 (FIG. 1) is implemented to determine the selectable character strings from the text that is displayed in the multiple display interfaces, such as by utilizing the character recognition application 134 to scan all of the displayed text. A selectable character string may be any one of a letter, a number, a symbol, a word, a phrase, a numeric string, an alphanumeric string, and/or any combination thereof that is viewable on the display component 202, such as in any of the various display interfaces in this example.

In an embodiment, the selectable character strings are determined from the text that is displayed in more than one of the display interfaces, if the keyboard interface 210 with the virtual keyboard 212 is displayed along with the other display interfaces. Alternatively, the selectable character strings are determined from the text that is displayed in only the active focus display interface. As shown, the messaging interface 206 is active and displayed over the website interface 204, and thus, the alternate embodiment would only determine selectable character strings from the messaging interface 206. The text entry application 110 can then generate the character string mapping table 122 that includes the selectable character strings as determined from one or more of the display interfaces (depending on the embodiment), and a corresponding selection position on the display component 202 for each of the selectable character strings in this example 200.

In this example of text select and enter, a user can select the selectable character strings, such as words and/or phrases that are displayed in the various display interfaces, and the selectable character strings are then duplicated as a text entry at a cursor position in the text edit field 208 without additional user input. As shown at 214, a cursor 216 is displayed that indicates the current text entry position as a user enters the text in the text edit field 208, such as with keyboard inputs (e.g., key select inputs or key swipe inputs) on the virtual keyboard 212. For example, the user can use the virtual keyboard 212 to enter text by way of standard-style key input typing, swipe-style typing, or another typing style using keys of the virtual keyboard. In addition to virtual keyboard-based text entry, the user can select character strings from the various display interfaces to create a text entry in the text edit field.

For example, the text entry application 110 can receive text entry key inputs of “You should drink” using the virtual keyboard and then a selection of the character string “Green Tea” as a touch contact 218 on the display component 202 in the website interface 204. The text entry application 110 can then determine the selectable character string from the character string mapping table 122 based on a selection position of the touch contact 218, and duplicate the character string as the text entry at the cursor position in the text edit field. Additionally, as shown at 220, the user can manually type the additional words “if you want to be” using the virtual keyboard 212 and select the character string “healthier” from the messaging interface 206 as a touch contact 222 on the display component 202, and the selectable character string is duplicated as a text entry in the text edit field 208 to compose the messaging response. Further, as shown at 224, the user can manually type the additional text “— it has” using the virtual keyboard 212 and then select the character string “potent antioxidants” from the website interface 204 as a touch contact 226 on the display component 202, and the selectable character string is duplicated as another text entry in the text edit field. Thus, implementation of text select and enter can reduce the time it takes to enter text as well as reduce spelling errors.

In implementations, a touch contact on the display component 202 to initiate the selection of a selectable character string can be distinguished from a different style of touch contact on the touch-sensitive display component to switch display interface focus from one display interface to another, such as to switch focus to the website interface 204 that would then be displayed over the messaging interface 206, and over the keyboard interface 210 and the text edit field 208. In an implementation, a user can select a selectable character string for entry in the text edit field with a single-tap or single-swipe touch contact (e.g., a short duration selection or quick touch contact). Alternatively, the user can initiate a display interface focus switch to a different display interface with a double-tap touch contact (e.g., two quick touch contacts in succession), or alternatively, direct cursor placement and control within the active display interface (e.g., the messaging interface 206) with an extended duration touch contact (e.g., a press and hold selection). In practice, a short duration is relative to an extended duration (and vice-versa), and the length of a selection for a short or extended duration can be implementation specific and/or user adjustable.

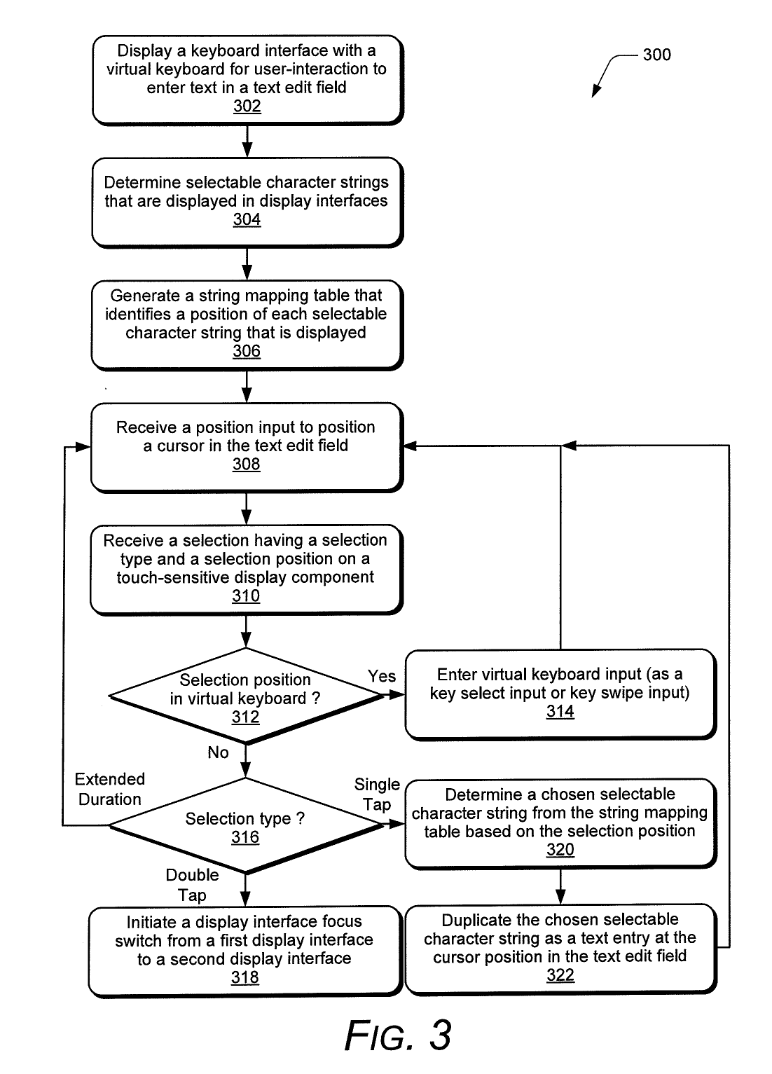

Example method 300 is described with reference to FIG. 3 in accordance with one or more embodiments of text select and enter. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 3 illustrates example method(s) 300 of text select and enter. The order in which the method blocks are described are not intended to be construed as a limitation, and any number or combination of the described method blocks can be performed in any order to implement an embodiment of a text select and enter method.

At block 302, a keyboard interface is displayed that includes a virtual keyboard for user-interaction to enter text in a text edit field. For example, the keyboard interface 114 (FIG. 1) is displayed on the touch-sensitive display component 106 of the electronic device 102, and the keyboard interface includes the virtual keyboard 116 that is displayed for user-interaction to enter the text 118 in the text edit field 120. In embodiments, the text edit field 120 is an example of a display interface that is displayed proximate the keyboard interface 114. In another example, the keyboard interface 210 (FIG. 2) includes the virtual keyboard 212 and is displayed on the display component 202 while the text edit field 208 is part of a messaging interface 206. Additionally, the website interface 204, the messaging interface 206, and the text edit field 208 (e.g., also a display interface) are all displayed on the display component 202 proximate the keyboard interface 210.

At block 304, selectable character strings are determined that are displayed in one or more display interfaces. For example, the text entry application 110 at the electronic device 102 determines the selectable character strings that are displayed in the text edit field 120 (e.g., a display interface). In an implementation, the selectable character strings are determined by optical character recognition of the display interface, such as utilizing the character recognition application 134 at the electronic device 102. A selectable character string may be any one of a letter, a number, a symbol, a word, a phrase, a numeric string, an alphanumeric string, and/or any combination thereof. In another example, the text entry application 110 determines the selectable character strings that are displayed in multiple display interfaces, such as by utilizing the character recognition application 134 to scan all of the visible text from the website interface 204, the messaging interface 206, and the text edit field 208 (e.g., also a display interface). A first display interface may at least partially overlap a second display interface, in which case the character strings of the second display interface that are not obscured by the first display interface are determined as the selectable character strings that are displayed in the second display interface.

At block 306, a string mapping table is generated that identifies a position of each selectable character string that is displayed. For example, the text entry application 110 at the electronic device 102 generates the character string mapping table 122 that includes the selectable character strings 124 as determined from the text edit field 120 (e.g., a display interface), and a corresponding selection position 126 on the display component 106 for each of the selectable character strings. In another example, the text entry application 110 generates the character string mapping table 122 that includes the selectable character strings and corresponding selection positions as determined from the website interface 204, the messaging interface 206, and the text edit field 208 that are all displayed on the display component 202.

At block 308, a position input is received to position a cursor in the text edit field. For example, the text entry application 110 at the electronic device 102 receives a position input to position the cursor 128 in the text edit field 120, such as when a user selects and moves the cursor for editing purposes. When a text entry application (e.g., messaging, database, word processing, etc.) initially launches, the text entry field is blank except for a cursor at an initial location. Later, when text is entered, the user can reposition the cursor within the entered text. The cursor 128 may be selected and can be positioned at any position in the text edit field 120, such as at the end of the text entry, at the beginning of the text entry, or anywhere in the displayed text. Alternatively, the cursor may remain at the end of the text entry by application default as a user enters text in the text edit field.

At block 310, a selection is received that is of a selection type and at a selection position on a touch-sensitive display component. For example, the touch detection system 104 at the electronic device 102 includes the touch-sensitive display component 106, which can receive different styles of touch contacts, such as a single-tap touch contact, a single-swipe contact, a double-tap touch contact, or an extended duration touch contact. In embodiments, a touch contact on the display component 202 to initiate choosing a selectable character string can be distinguished from a different style of touch contact on the touch-sensitive display component to switch display interface focus from one display interface to another, or to direct cursor placement and control within an active display interface.

As an alternative to generating a string mapping table at step 306 prior to receiving the selection at block 310, a string mapping table could be generated after receiving the selection at block 310. Such a dynamically-generated string mapping table could have only one entry, which maps the selection position from block 310 to a selectable character string.

At block 312, a determination is made as to whether the selection position of the selection is within a virtual keyboard interface. For example, a user can enter text in the text edit field 120 with keyboard inputs (e.g., key select inputs or key swipe inputs) on the virtual keyboard 116 that is displayed in the keyboard interface 114. In another example, the user can enter text in the text edit field 208 with keyboard inputs (e.g., key select inputs or key swipe inputs) on the virtual keyboard 212 that is displayed in the keyboard interface 210. If the selection position of the selection (e.g., received at block 310) is within a virtual keyboard interface (i.e., “yes” from block 312), then at block 314, the virtual keyboard input is entered in a text edit field or application display interface at the current cursor position. The method then continues at block 308 to receive a position input to position (or re-position) the cursor in the text edit field, or the cursor may remain at the end of the text entry by application default.

If the selection position of the selection (e.g., received at block 310) is not within a virtual keyboard interface (i.e., “no” from block 312), then at block 316, a determination is made as to the selection type of the selection on the touch-sensitive display component. For example, a user can choose a selectable character string for entry in the text edit field 120 with a single-tap or single-swipe touch contact (e.g., a short duration selection or quick touch contact) on the touch-sensitive display component 106. Alternatively, the user can initiate moving the cursor 128 with an extended duration touch contact (e.g., a press and hold selection). In another example, a user can choose a selectable character string for entry in the text edit field 208 with a single-tap or single-swipe touch contact (e.g., a quick touch contact) on the display component 202. Alternatively, the user can initiate a display interface focus switch to a different display interface with a double-tap touch contact (e.g., two quick touch contacts in succession). As yet another option, the user can initiate direct cursor placement and control within the active display interface (e.g., the messaging interface 206) with an extended duration touch contact (e.g., a press and hold selection).

If the selection type is an extended duration touch contact as determined at block 316, then the method returns to block 308 to position (or re-position) the cursor in the text edit field, or the cursor may remain at the end of the text entry by application default. For example, the text entry application 110 at the electronic device 102 receives the extended duration touch contact as a position input to position the cursor 128 in the text edit field 120, such as when a user selects and moves the cursor for editing purposes. If the selection type is a double-tap touch contact as determined at block 316, then at block 318, a display interface focus switch from a first display interface to a second display interface is initiated. For example, the text entry application 110 initiates the display interface focus switch from a first display interface to a second display interface based on the double-tap touch contact, such as to switch focus to the website interface 204 that would then be displayed over the messaging interface 206, and over the keyboard interface 210 and the text edit field 208. The method may then end or continue at block 302 to display the keyboard interface with the virtual keyboard for user-interaction to enter text in a text edit field.

If the selection type is a single-tap touch contact as determined at block 316, then the selection (e.g., received at block 310) is of a selectable character string that is displayed in a display interface. For example, the text entry application 110 at the electronic device 102 receives a selection of a character string 124 that is displayed in the text edit field 120 (e.g., a display interface), such as the word “text” or the phrase “text edit field”, when a user selects the previously typed word or phrase from the text edit field. In another example, a user can select the character string “Green Tea” from the website interface 204, select the character string “healthier” from the messaging interface 206, and select the character string “potent antioxidants” from the website interface 204 as text entries that are entered in the text edit field 208.

At block 320, the chosen selectable character string is determined from the string mapping table based on the selection position on the touch-sensitive display component. For example, the text entry application 110 at the electronic device 102 determines the selectable character string 124 from the character string mapping table 122 based on the corresponding selection position 126 on the display component 106 (FIG. 1), or on the display component 202 (FIG. 2). The text entry application 110 receives the touch input data 108 from the touch detection system 104, where the touch input data correlates to the selection position of the chosen selectable character string, and the text entry application determines the selectable character string from the selection position.

At block 322, the chosen selectable character string is duplicated as a text entry at the cursor position in the text edit field. For example, the text entry application 110 at the electronic device 102 duplicates the selectable character string (e.g., the word “text”, or the phrase “text edit field”) as a text entry at the cursor 128 position in the text edit field 120. The text entry is duplicated at the cursor position in the text edit field responsive to the selection of the character string and without additional user input. In another example, the text entry application 110 duplicates the chosen selectable character strings (e.g., the phrase “Green Tea” from the website interface 204, the word “healthier” from the messaging interface 206, and the phrase “potent antioxidants” from the website interface 204) as text entries in the text edit field 208. The method then continues at block 308 to receive a position input to position (or re-position) the cursor in the text edit field, or the cursor may remain at the end of the text entry by application default.

Although a single-tap or single-swipe touch contact has been described as an example of a touch style that directs text select and enter, an alternate touch style may be used to initiate text select and enter. Additionally, although three specific examples of touch styles have been described (e.g., extended duration, single-tap or single-swipe, and double-tap) with three associated responses (e.g., cursor positioning, character string selection, and focus switch), touch styles may be matched to responses in many other ways.

FIG. 4 illustrates various components of an example electronic device 400 that can be implemented as any device described with reference to any of the previous FIGS. 1-3. The electronic device may be implemented as any one or combination of a fixed or mobile device, in any form of a consumer, computer, portable, user, communication, phone, navigation, gaming, messaging, Web browsing, paging, and/or other type of electronic device, such as the electronic device 102 described with reference to FIG. 1.

The electronic device 400 includes communication transceivers 402 that enable wired and/or wireless communication of device data 404, such as received data and transmitted data plus locally entered data. Example communication transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN, 3GPP-compliant) radios for cellular telephony, wireless metropolitan area network (WMAN) radios compliant with various IEEE 802.15 (WiMAX™) standards, and wired local area network (LAN) Ethernet transceivers.

The electronic device 400 may also include one or more data input ports 406 via which any type of data, media content, and/or inputs can be received, such as user-selectable inputs, messages, music, television content, recorded video content, and any other type of audio, video, and/or image data received from any content and/or data source. The data input ports 406 may include USB ports, coaxial cable ports, and other serial or parallel connectors (including internal connectors) for flash memory, DVDs, CDs, and the like. These data input ports may be used to couple the electronic device to components, peripherals, or accessories such as keyboards, microphones, or cameras.

The electronic device 400 includes one or more processors 408 (e.g., any of microprocessors, controllers, and the like), or a processor and memory system (e.g., implemented in an SoC), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 412. The electronic device also includes a touch detection system 414 that is implemented to detect and/or sense touch contacts, such as when initiated by a user as a selectable touch input on a touch-sensitive interface integrated with the device. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 400 also includes one or more memory devices 416 that enable data storage, examples of which include random access memory (RAM), non-volatile memory (e.g., read-only memory (ROM), flash memory, EPROM, EEPROM, etc.), and a disk storage device. A memory device 416 provides data storage mechanisms to store the device data 404, other types of information and/or data, and various device applications 418 (e.g., software applications). For example, an operating system 420 can be maintained as software instructions with a memory device and executed by the processors 408. The memory devices 416 also store the touch input data 108 and/or the character string mapping table 122 at the electronic device 102.

The device applications may also include a device manager, such as any form of a control application, software application, signal-processing and control module, code that is native to a particular device, a hardware abstraction layer for a particular device, and so on. In embodiments, the electronic device includes a text entry application 410 and/or a character recognition application 428 to implement text select and enter. Example implementations of the text entry application 410 and the character recognition application 428 are described with reference to the text entry application 110 and the character recognition application 134 (FIG. 1).

The electronic device 400 also includes an audio and/or video processing system 422 that processes audio data and/or passes through the audio and video data to an audio system 424 and/or to a display system 426. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 430. In implementations, the audio system and/or the display system are external components to the electronic device. Alternatively or in addition, the display system can be an integrated component of the example electronic device, such as part of an integrated touch gesture interface.

As described above, a selectable character string, such as a word or phrase that is displayed in a text edit field, or in an application or display interface, can be selected and the selectable character string is then duplicated as a text entry at a cursor position in the text edit field without additional user input. As the user enters text in the text edit field of a virtual keyboard, the user can save time by selecting previously typed words or phrases that are then entered as text entries. A text entry is duplicated at a cursor position in a text edit field responsive to the selected phrase being selected and without additional user input. Although embodiments of text select and enter have been described in language specific to features and/or methods, the subject of the appended claims is not necessarily limited to the specific features or methods described. Rather, the specific features and methods are disclosed as example implementations of text select and enter.

1. A method, comprising:
displaying a keyboard interface that includes a virtual keyboard configured for user interaction to enter text in a text edit field using keyboard inputs;
determining selectable character strings that are displayed in at least one display interface that is positioned proximate the keyboard interface, the at least one display interface displayed concurrently with the virtual keyboard and the text edit field of the keyboard interface;
receiving a selection of a selectable character string that is displayed in the display interface; and
duplicating the selectable character string as a text entry at a cursor position in the text edit field responsive to the selection of the selectable character string and without additional user input.

2. The method of claim 1, further comprising:
generating a string mapping table that identifies a position of each selectable character string that is displayed in the display interface; and
determining the selectable character string from the string mapping table based on a selection position on a display component that displays the keyboard interface and the display interface.

3. The method of claim 1, wherein:
the selectable character string comprises one of: a letter, a number, a symbol, a word, a phrase, a numeric string, or an alphanumeric string, and
the selectable character string is determined by optical character recognition of the display interface.

4. The method of claim 1, further comprising:
receiving an additional selection that is detected on a display component that displays the keyboard interface and the display interface;
positioning a cursor in the text edit field at an input position of the additional selection, if the additional selection is received as an extended duration selection; and
initiating a display interface focus switch from the display interface to another display interface, if the additional selection is received as a double-tap input.

5. The method of claim 1, further comprising:
receiving another selection of an additional selectable character string is displayed in the text edit field,
wherein the additional selectable character string is duplicated as the text entry at the cursor position in the text edit field responsive to the selection of the additional selectable character string from the text edit field.

6. The method of claim 1, wherein:
the selectable character string is a selected phrase, and
the selected phrase is duplicated as the text entry at the cursor position in the text edit field based on the selection and without the additional user input.

7. The method of claim 1, wherein:
the display interface is a Web browser,
the selectable character string is displayed in the Web browser, and
the selectable character string is duplicated as the text entry at the cursor position in the text edit field.

8. The method of claim 1, wherein the receiving a selection comprises receiving touch-style data of a touch contact, and the method further comprises:
said duplicating the selectable character string as the text entry at the cursor position in the text edit field, if the touch-style data corresponds to a first style of touch contact; and
initiating a display interface focus switch from a first display interface to a second display interface, if the touch-style data corresponds to a second style of touch contact.

9. An electronic device, comprising:
a display component configured to display a virtual keyboard in a keyboard interface;
a touch detection system configured to detect a touch contact on a touch-sensitive interface of the display component; and
a memory and processor system configured to execute a text entry application that is configured to:
determine selectable character strings that are displayed in at least one display interface on the display component;
generate a string mapping table that identifies a position of each selectable character string that is displayed in the display interface, the position of a selectable character string identified by coordinates of the display component;
receive position data of the touch contact;
reference the string mapping table to identify a chosen selectable character string that correlates to the position data; and
duplicate the chosen selectable character string as a text entry at a cursor position in a text edit field.

10. The electronic device of claim 9, wherein the selectable character strings each comprise one of: a letter, a number, a symbol, a word, a phrase, a numeric string, or an alphanumeric string.

11. The electronic device of claim 9, wherein the memory and processor system is configured to execute a character recognition application that is configured to determine the selectable character strings that are displayed in the display interface.

12. The electronic device of claim 9, wherein the text entry application is further configured to receive touch-style data of the touch contact, and one of:
duplicate the chosen selectable character string as the text entry at the cursor position in the text edit field if the touch-style data corresponds to a first style of touch contact,
position a cursor in the text edit field at an input position of the touch contact if the touch-style data corresponds to a second style of touch contact, or
initiate a display interface focus switch from the display interface to another display interface if the touch-style data corresponds to a third style of touch contact.

13. The electronic device of claim 9, wherein:
the display interface is the text edit field,
the selectable character string is displayed in the text edit field, and
the chosen selectable character string is duplicated as the text entry at the cursor position in the text edit field.

14. The electronic device of claim 9, wherein:
the selectable character string is a selected phrase; and
the selected phrase is duplicated as the text entry at the cursor position in the text edit field based on the touch contact and without additional user input.

15. The electronic device of claim 9, wherein:
the display interface is Web browser;
the selectable character string is displayed in the Web browser; and
the chosen selectable character string is duplicated as the text entry at the cursor position in the text edit field.

16. A method, comprising:
displaying a keyboard interface that includes a virtual keyboard configured for user-interaction to enter text in a text edit field that is displayed proximate the keyboard interface;
receiving a position input to position a cursor in the text edit field;
receiving a selection of a character string that is displayed in the text edit field; and
duplicating the character string as a text entry at the cursor position in the text edit field responsive to the selection of the character string and without additional user input.

17. The method of claim 16, wherein:
the character string is a selected phrase that is displayed in the text edit field, and
the selected phrase is duplicated as the text entry at the cursor position in the text edit field.

18. The method of claim 16, wherein the character string comprises one of: a letter, a number, a symbol, a word, a phrase, a numeric string, or an alphanumeric string.

19. The method of claim 16, further comprising:
determining selectable character strings that are displayed in multiple display interfaces that include the text edit field; and
generating a string mapping table that identifies a position of each selectable character string that is displayed in the multiple display interfaces.

20. The method of claim 16, wherein:
a first display interface at least partially overlaps a second display interface, and
character strings of the second display interface that are not obscured by the first display interface are determined as the selectable character strings that are displayed in the second display interface.
